(19) United States
(12) Patent Application Publication
(10) Pub. No.: US 2016/0291849 A1
(43) Pub. Date: Oct. 6, 2016

(54) MULTI-TOUCH INTERFACE FOR VIRTUAL MANIPULATION OF THREE-DIMENSIONAL SEISMIC DATA

(71) Applicant: SHELL OIL COMPANY, Houston, TX (US)

(72) Inventors: Mark Edward STOCKWELL, Sugar Land, TX (US); Brandon Leigh WALLACE, Houston, TX (US); Lynn PAUSIC, Austin, TX (US); Blake COFFMAN, Tomball, TX (US)

(21) Appl. No.: 15/037,215

(22) PCT Filed: Nov. 17, 2014
(86) PCT No.: PCT/US2014/065886

§ 371 Date: May 17, 2016

Related U.S. Application Data
(60) Provisional application No. 61/906,266, filed on Nov. 19, 2013.

(51) Int. Cl. G06F 3/0484; G06F 3/0481; G06F 3/0488

(52) U.S. Cl. CPC G06F 3/04845; G06F 3/04883; G06F 3/04886; G06F 3/04815; G06F 2203/04808; G06F 2203/04806

(57) ABSTRACT

A system for manipulating an image of a three-dimensional data volume comprises a data processing system, a touch screen electrically connected to the processing system so as to recognize a plurality of gestures, and a visual representation of a three-dimensional data volume displayed on the touch screen, wherein the processing system is configured to allow a user to select, view, and move a cross-section of said data volume by tapping a desired portion of the visual representation twice with a contact device and moving the contact device across the touch screen while maintaining contact with the touch screen after the second tap.

### FIELD OF THE INVENTION

In an aspect the invention relates to a system for manipulating an image of a three-dimensional data volume. In another aspect the invention relates to method for manipulating seismic data.

### BACKGROUND OF THE INVENTION

Three-dimensional projections of seismic data, including volumetric data, are a sophisticated way to provide researchers with information regarding subsurface resources such as oil, water, and natural gas. Oil and natural gas are important commodities in the world's supply of energy resources. As such, the location and production of subsurface resources is a significant activity in the energy industry, with several companies dedicating immense time and effort to the location and extraction of oil and natural gas from beneath the earth's surface.

To locate an oil reservoir, researchers use various techniques. One such technique is volumetric seismic data mapping. Seismic data comprises seismic source waves that are transmitted into the earth and reflected. The reflected signals can be processed to allow researchers to visualize the volume of these materials in three dimensions. This information, in turn, allows researchers to predict where hydrocarbons might be found below the surface of a region. Recent technological advances have allowed researchers to visualize and track seismic volumetric data through the display of complex, virtual three-dimensional images on interactive machines.

Typically, seismic data comprises a reading of several datasets or “traces” representing the acoustic signal detected by a remote sensor after the signal has been transmitted by a seismic source and passed through the subsurface. When several seismic sources transmit acoustic signals throughout a subsurface region, each sensor will receive multiple signals representing different flow paths through the subsurface. When a researcher organizes these traces for a particular subsurface region into a “stack,” he or she can use the data to help predict whether that subsurface region contains hydrocarbons.

At the same time, the widespread use of multiple input touch screens (multi-touch) has improved the computer-human interface, and thus enhanced researchers' ability to view and manipulate seismic data. A multi-touch interface provides researchers with an intuitive way to interact with a computer or other interactive device. With multi-touch, a computer screen acts as both a display device and an input device. Through use of a multi-touch, researchers can quickly and intuitively evaluate a complex display of information to determine which sites offer the most potential for extracting energy resources.

Though computer visualization technologies offer an opportunity for researchers to view and manipulate three-dimensional (3D) visualizations of seismic traces, this potential is unrealized without a library of methods for interacting with the screen. Several devices currently use multi-touch technology and gestures for a user interface, but there remains a need for an improved interface for manipulating sophisticated 3D volumetric data, including but not limited to seismic data. For instance, in the context of seismic data, the use of a touch screen often requires the use of “virtual buttons,” or icons located on the screen, which a user must select in order to vary their interaction with the interface. An array of “virtual buttons” takes up space on the screen and reduces the intuitiveness of the user interface. There is thus a need for improved functionality in the display and manipulation of seismic data.

### SUMMARY OF THE INVENTION

In one aspect, the invention provides a system for manipulating an image of a three-dimensional data volume comprising:
a data processing system;
a touch screen electrically connected to said processing system so as to recognize a plurality of gestures; and
visual representation of a three-dimensional data volume displayed on said touch screen;
   wherein the processing system is configured to allow a user to select, view, and move a cross-section of said data volume by tapping a desired portion of said visual representation twice with a contact device and moving said contact device across said touch screen while maintaining contact with said touch screen after the second tap.

In another aspect, the invention provides a method for manipulating seismic data comprising:

a) displaying an image of a three-dimensional data volume on a touch screen;

b) selecting a cross-section of the three-dimensional data volume by twice tapping a desired portion of said touch screen with a contact device;

c) displaying the selected cross-section; and,

d) translating the displayed cross-section through the three-dimensional data volume so as to display the cross-section at different locations in the three-dimensional data by moving the contact device across said touch screen while maintaining contact therewith.

### BRIEF DESCRIPTION OF THE DRAWINGS

For a more detailed understanding of the invention, reference is made to the accompanying drawings wherein:

FIG. 1 is a diagram of a system displaying 3D seismic data.

FIG. 2 (parts a to d) is a diagram of preferred sub-actions used to execute the “tap, tap-drag” gesture on a multi touch.

### DETAILED DESCRIPTION OF A PREFERRED EMBODIMENT

The invention relates to providing a system for the display and advanced manipulation of three-dimensional seismic data simulations. Three-dimensional projections of seismic data, including volumetric data, are a sophisticated way to provide researchers with information regarding subsurface resources such as oil, water, and natural gas.

As used in this specification and claims the following terms shall have the following meanings: “3D” refers to “three-dimensional,” or any computer-generated image in which the displayed items have a length, width, and depth.

“Multi touch” refers to an electronic display screen with which the user can interact by pressing one or more fingers against the screen at once, capable of recognizing several predefined forms of input including tapping, dragging, pinching, and performing multi-finger motions with more or fewer points of contact.

“Tap, tap-drag” refers to a predefined multi-touch display gesture wherein the user performs two successive taps and leaves his or her finger in contact with the screen after the second tap. As long as the finger remains in contact with the screen, dragging it across the screen will relay electronic signals to the data system resulting in a desired manipulation of the visualized data.

“Seismic” refers to a type of data for measuring the subsurface reflectivity of various geological materials and formations, used to predict the content of subsurface materials.

In accordance with preferred embodiments of the invention there is provided a multi-touch interface for the display and manipulation of 3D seismic data. Among other advantages, the present system improves a researcher's ability to understand and manipulate a display of 3D volumetric data pertaining to an area. The present system allows a user to intuitively rotate a 3D seismic data display while also allowing the user to zoom, rotate, pan, switch, and move individual traces of data.

Still another advantage of the invention to is provide, without virtual buttons, multiple single-finger methods for interacting with data that expand a user's array of options for using and visualizing the data. By way of example, the invention provides a command for interacting with seismic data in which a user may tap a slice of seismic data, followed quickly by a tap drag gesture in which the user taps his or her finger onto the screen and, without lifting the finger, drags it to move a slice or other subset of data through the data volume as an aid to visualizing it.

In certain embodiments, the present system for manipulating an image of seismic data comprises a data processing system, a touch screen electrically connected to said processing system so as to recognize a plurality of gestures, and a seismic image displayed on the touch screen. The seismic image comprises a visual representation of a three-dimensional data volume, and the processing system is configured to allow a user to select, view, and move a cross-section of said data volume by tapping a desired portion of said seismic image twice with a contact device and moving said contact device across said touch screen while maintaining contact with said touch screen

This type of interactive command, sometimes referred to as “tap, tap-drag,” is a new way to interact with 3D displays of seismic data. Through use of tap, tap-drag as a unique command, the separate actions of tapping or dragging alone may be reserved for performing other essential functions such as zooming and rotation. As a result, a researcher may simply drag the 3D image displayed on the touch screen in order to rotate it, tap the screen to make a selection, or pinch the image with two fingers to zoom in and out. However, when a researcher wishes to move a selected data slice through display, tap-drag permits a user to translate subsets of the data without requiring virtual buttons or necessitating additional commands in the user interface.

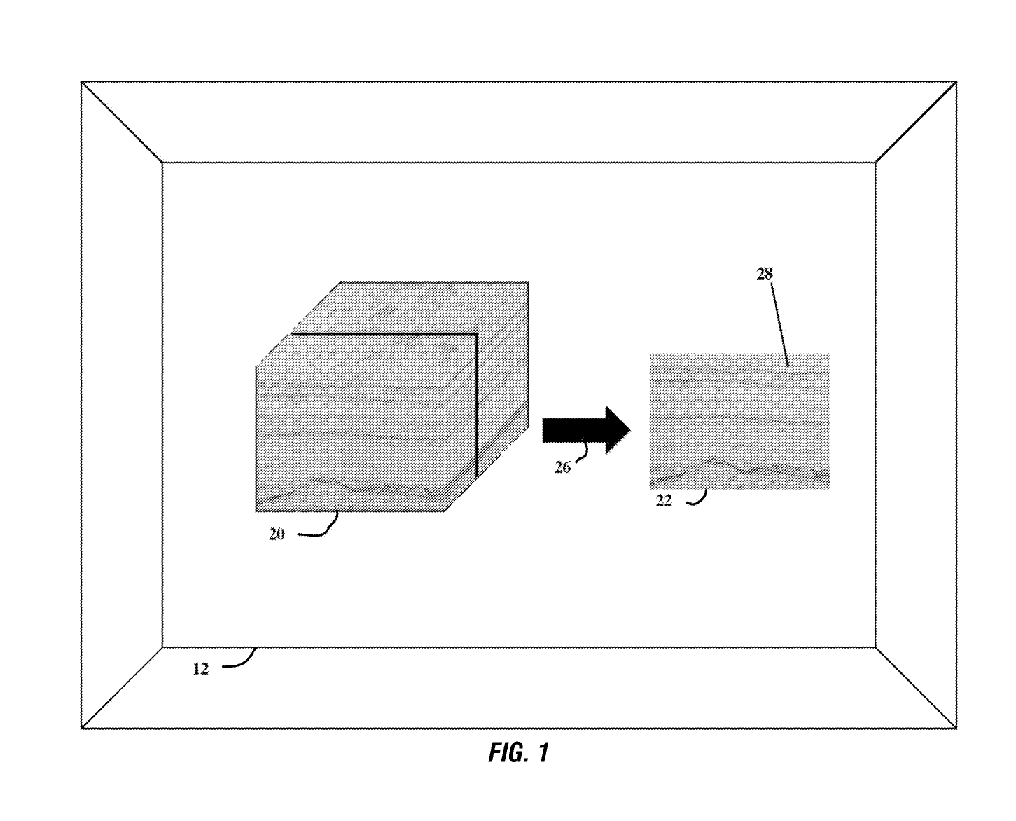

Referring to FIG. 1, a diagram of a multi touch displaying an interactive representation of seismic data is provided. An embodiment of the invention enables users of a system displaying 3D volumetric seismic data to manipulate the data intuitively by extracting and moving a slice of the seismic data through a simple hand gesture. The components of a user interface for achieving this objective are provided and will now be explained.

Imaging hardware (not shown) provides the framework for interacting with a preferred embodiment. The imaging hardware is powered by a processing system (also not shown) and may include conventional devices such as a desktop computer, laptop computer, tablet, etc. with sufficient processing power to display interactive images in 3D. The imaging hardware preferably includes a multi touch screen 12, which is capable of recognizing tactile input. For example, as is known in the art, multi touch screen 12 recognizes when a user places one finger on the screen or two fingers on the screen, and can differentiate between a user's tap on the screen or dragging of a finger across the screen, in addition to more sophisticated gestures such as pinches and relative rotation of one finger around another.

The connection of imaging hardware to a multi-touch screen 12 enables the components of this embodiment to function in the desired manner.

The following description of the invention is presented in the context of visualizing seismic data. It will be understood, however, that the present invention is applicable to any virtual “slice” through volumetric data. Thus, for example, medical imaging data, climate data, etc could all benefit from the techniques described below.

Referring again to FIG. 1, in a seismic application, multi touch screen 12 displays a 3D visual representation 20 of seismic data collected for a particular subsurface region. 3D representation 20 is typically assembled using known seismic data processing techniques. The 3D representation 20 may contain a variety of graphics including surfaces, polylines, text, voxels or other graphics. The 3D representation 20 can be thought of as an array of two-dimensional “slices” 22. Within each slice are several waveforms 28 representing signals reflected by subsurface features. Each slice 22 represents a two dimensional projection of a section of seismic volume data 20. The imaging hardware is capable of extracting individual slices 22 from the 3D representation 20 so that a user may better determine the features in a complex subsurface region.

In preferred embodiments, while viewing seismic volume 20, a user can rotate the perceived viewing angle through use of a single finger drag gesture on multi-touch screen 12. In addition, the user may use two fingers “pinch close” or “pinch open” in order to zoom-in or zoom-out on the image. In further preferred embodiments, the user may use a three-finger gesture to pan the screen and a four-finger gesture to close it.

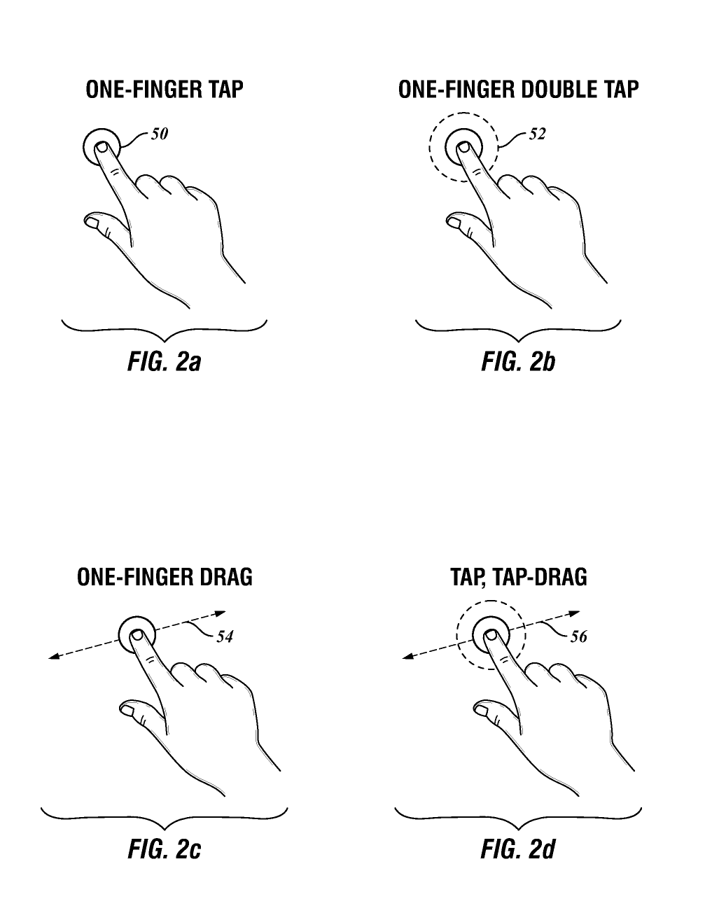

Preferred embodiments of the present invention offer additional functionality by providing the user with a way, through a multi-touch gesture, to translate a two-dimensional (2D) “slice” of data 22 within volume 20. Turning to FIG. 2 (parts a to d), the multi-touch gesture referred to as “tap, tap-drag” combines two known multi-touch gestures, providing additional functionality for gestures performed with one finger.

An existing gesture that is analogous to “clicking” and which may be performed in the simulated environment of seismic data is the single tap gesture 50 illustrated in FIG. 2a under the name “one-finger tap”. This gesture allows a user to select a particular spot on the map for examination by simply tapping his or her finger against the screen. In addition, the user may rotate the three dimensional representation of an environment by dragging his or her finger across the screen after a single tap gesture 50. This drag gesture 54 is illustrated in FIG. 2c under the name “one-finger drag”.

Similarly, a user may execute a program function by tapping a point in the three-dimensional virtual map twice in succession. This double tap gesture 52, illustrated in FIG. 2b under the name “one-finger double tap”, may be analogous to a double-click when executing commands or triggering commands on a computer operating system with a mouse. This gesture is simply two single tap gestures 50 performed within a pre-specified and relatively short time, which the computer will recognize as double tap gesture 52, distinct from the single tap gesture 50 or two single tap gestures. Depending on the application, the double tap gesture (or double-click) may select an icon, open a folder, or in the present case, select a slice of seismic data without moving it.

In the preferred embodiments, a tap, tap-drag gesture 56 is effectively a combination of one double tap gesture 52 and one drag gesture 54. The tap, tap-drag gesture 56 is illustrated in FIG. 2d under the name “tap, tap-drag”. To execute the tap, tap-drag gesture 56, a user taps his or her finger, or other suitable contact device, twice against the multi touch screen and keeps the finger in contact with the screen following the second tap. From here, the user moves his or her finger across the screen while maintaining contact with the touch-screen, which motion may be referred to as “dragging.” A multi-touch library can be configured to recognize the tap, tap-drag gesture 56 as a distinct action. In a preferred embodiment of the invention, this gesture will cause the system to select a slice of seismic data, highlight it within the existing volumetric simulation, and then slide the plane of the slice through the data volume. Using a tap, tap-drag gesture 56, the user can use a single gesture to manipulate the display of data subsets without performing additional gestures or requiring intermediate commands.

The addition of tap, tap-drag gesture 56 allows for greater possibilities and functionality in manipulating seismic data than would be possible when only single tap gesture 50, double tap gesture 52, or (single finger) drag gesture 54 are available in isolation. Including the tap-drag gesture 56 when manipulating seismic data provides an intuitive approach for users to both rotate the field of data and drag slices of seismic data from one location to another. After executing a tap, tap-drag gesture 56, a single drag gesture 54 again preferably serves to rotate the field of data until another tap, tap-drag gesture 56 is performed.

The embodiments of the present invention have been described with reference to visual representation of a three-dimensional data volume displayed on the touch screen. It will be clear to the person skilled in the art that 3D display of data does not exclude the possibility that the underlying data can have more than three dimensions whereby the invention provides for a 3D visualization of a data volume having more than three dimensions.

Although the preferred embodiments of the present invention have been described herein, the above description is merely illustrative. Further modifications of the invention herein disclosed may occur to those skilled in the respective arts, and all such modifications are deemed to be within the scope of the invention as described by the appended claims. By way of example only, other touch sequences could be adapted to provide the same functionality as in the present invention. Likewise, other visual interpretation techniques could be assigned to other touch sequences in order to achieve a user-friendly data interpretation system. In addition, unless expressly so recited, the sequential recitation of steps is not intended as a requirement that the steps be performed either in the order recited or sequentially.

1. A system for manipulating an image of a three-dimensional data volume comprising:
a data processing system;
a touch screen electrically connected to said processing system so as to recognize a plurality of gestures; and,
visual representation of a three-dimensional data volume displayed on said touch screen;
wherein the processing system is configured to allow a user to select, view, and move a cross-section of said data volume by tapping a desired portion of said visual representation twice with a contact device and moving said contact device across said touch screen while maintaining contact with said touch screen after the second tap.

2. The system of claim 1 wherein said touch screen recognizes simultaneous contacts.

3. The system of claim 1 wherein said three-dimensional data volume comprises a seismic data volume.

4. The system of claim 1 wherein said three-dimensional data volume is displayed in two dimensions as a three-dimensional virtual map.

5. The system of claim 1 wherein said plurality of gestures further comprises a single tap, a dragging motion, and two successive taps.

6. The system of claim 5 wherein said plurality of gestures further comprises at least one gesture performed with two or more fingers.

7. A method for manipulating seismic data comprising:
a) displaying an image of a three-dimensional data volume on a touch screen;
b) selecting a cross-section of the three-dimensional data volume by twice tapping a desired portion of said touch screen with a contact device;
c) displaying the selected cross-section; and,
d) translating the displayed cross-section through the three-dimensional data volume so as to display the cross-section at different locations in the three-dimensional data by moving the contact device across said touch screen while maintaining contact therewith.

8. The method of claim 7 wherein said touch screen recognizes simultaneous contacts.

9. The method of claim 7 wherein said seismic data are displayed on a three-dimensional virtual map.
